(19) United States
(12) Patent Application Publication
(10) Pub. No.: US 2022/0385156 A1
(43) Pub. Date: Dec. 1, 2022

(54) AXIAL FLUX MOTOR WITH VARIABLE GAP

(71) Applicant: dormakaba Deutschland GmbH, Ennepetal (DE)

(72) Inventor: Matthias VETTER, Ennepetal (DE)

(21) Appl. No.: 17/752,307

(22) Filed: May 24, 2022

(30) Foreign Application Priority Data
May 26, 2021 (EP) 21176063.2

(51) Int. Cl. H02K 21/02; H02K 21/24; H02K 7/08

(52) U.S. Cl. CPC H02K 21/026; H02K 21/24; H02K 7/085

(57) ABSTRACT

An axial flux motor and a method for operating the same, in particular for driving at least one leaf element of a door, of a gate, of a window, of a person separation device and/or of a partition wall system, include a magnet unit and having a coil unit, with the magnet unit being designed so as to be rotatable about a rotational axis, and with a gap being designed between the magnet unit and the coil unit. An actuation unit is provided, with which the gap between the magnet unit and the coil unit is variable, in particular enlargeable.

### CROSS-REFERENCE TO RELATED APPLICATIONS

This application is related to and claims the benefit of European Patent Application No. 21176063.2, filed on May 26, 2021, the contents of which are herein incorporated by reference in their entirety.

### TECHNICAL FIELD

The disclosure relates to an axial flux motor in particular for driving at least one leaf element of a door, of a gate, of a window, of a person separation device and/or of a partition wall system, having a magnet unit and having a coil unit, with the magnet unit being designed so as to be rotatable about a rotational axis, and with a gap being designed between the magnet unit and the coil unit.

BACKGROUND

Axial flux motors have a structure, according to which a magnet unit and a coil unit are opposite one another in a rotational axis. Depending on the motor type, either the coil unit or the magnet unit can be thereby set into rotation. The unit that can be set into rotation is connected to an output shaft to provide a drive in order to provide for example a leaf element for a door, for a gate, for a window or for a person separation device, commonly known as a turnstile, or for a partition wall system.

In the resting state, axial flux motors have a cogging torque on the output shaft since the magnet units have permanent magnets which exert a magnetic force on the coil supports of the coils on which the coils of the coil unit as attached.

If the output shaft of the axial flux motor is rotated manually, an undulating torque curve is experienced, which sometimes leads to the output shaft being able to be set into rotational movement only with great force. The axial gap between the magnet unit and the coil unit is generally selected as small as possible since, in the case of a small air gap, the magnetic flux density is particularly high and the performance of the axial flux motor increases. In contrast, the cogging torque between the permanent magnets and the coil supports of the coils of the coil unit is also particularly strongly pronounced in the case of a small gap.

As a result, in the case of a manual drive of the output shaft, a cogging torque results which occurs periodically around the circumference and which, in particular in the case of transmission connections between the leaf element and the axial flux motor, leads to increased movement forces and torques in order to manually actuate the leaf element, for example, of a door or of a partition wall system, even when the axial flux motor is de-energized.

However, for reasons of comfort and in particular for reasons of safety, leaf elements for doors, gates, windows and the like are also intended to be moved manually with only moderate forces in the de-energized state of a drive comprising an axial flux motor such that in particular children, older adults and people with impairments can still pass through a door even if the drive and therefore the axial flux motor is not powered. Depending on the country, technical requirements must therefore in particular be meet, which often requires complex coupling systems in order to temporarily separate the operative connection from the axial flux motor to the leaf element and to decouple the axial flux motor.

### SUMMARY

The disclosure further develops an axial flux motor, which has a reduced cogging torque in the de-energized state. The disclosure thereby also provides a method for operating such an axial flux motor and to provide a drive for a door, a gate, a window, a person separation device and/or of a partition wall system which comprises such an axial flux motor.

This is achieved by proceeding from an axial flux motor according to the preamble of claim 1, proceeding from a method according to the preamble of the claim 13 and proceeding from a drive according to claim 15 each with the characterizing features. Advantageous further developments of the disclosure are indicated in the dependent claims.

The disclosure includes the technical teaching that an actuation unit is provided for the axial flux motor with which the gap between the magnet unit and the coil unit is temporarily enlargeable.

The disclosure relates to varying the cogging torque, in particular reducing the cogging torque by in particular temporarily enlarging the gap between the magnets of the magnet unit and the coils of the coil unit in order to notably reduce the cogging torque when manually driving the output shaft, for example by moving a door leaf or the like in the de-energized state of the axial flux motor. Then, when the axial flux motor is de-energized, in particular following a predefinable time period, the actuation unit can be activated in order to enlarge the gap between the magnets of the magnet unit and the coils of the coil unit such that the resulting cogging torque is notably reduced. If the axial flux motor is activated again, the actuation unit can reduce the gap again in order to restart a normal operation of the axial flux motor.

In other words, the gap is enlargeable and/or reducible in particular at least temporarily. In particular, the gap can be thereby reduced by means of the actuation unit in the activated, in particular powered, state of the axial flux motor. This enables higher performance of the motor. In particular, the gap can be thereby enlarged by means of the actuation unit in the passive, in particular non-powered, state of the axial flux motor. This enables a reduced cogging torque of the axial flux motor. Therefore, an easier manual actuation of the door system is made possible when using the motor in door systems.

In particular, the actuation unit is in interaction with the magnet unit such that the magnet unit is displaceable by means of an activation of the actuation unit relative to the coil unit in the rotational axis, in particular along the virtually extended rotational axis. Therefore, a first possibility is shown for changing the magnet unit in the axial position with respect to the coil unit by coupling the actuation unit to the magnet unit.

Additionally or alternatively, the actuation unit can be in interaction with the coil unit such that the coil unit is displaceable by means of an activation of the actuation unit relative to the magnet unit in the rotational axis, in particular along the virtually extended rotational axis. The interaction between the actuation unit and the coil unit thereby forms an alternative possibility since motors are also known which have a fixed connection between the output shaft and the magnet unit such that the coil unit is arranged in a resting manner. Advantageously, the actuation unit is brought into interaction with the part of the axial flux motor which does not form the rotating part, and even if the actuation unit is connected to the rotating part of the axial flux motor, a displacement of the magnet unit or, alternatively, of the coil unit on the output shaft itself is also possible.

In order to compensate for magnetic forces or to ensure a defined resting position of the magnet unit with respect to the coil unit, a spring unit can be provided, in particular formed from a plurality of spring elements, which pre-tension the magnet unit in the rotational axis against the coil unit.

In this case, when the actuation unit is activated, the magnet unit can be movable against the force of the spring unit or together with the force of the spring unit so as to enlarge the gap. Alternatively, when the actuation unit is deactivated, the magnet unit can be movable by means of the force of the spring unit so as to enlarge the gap.

Alternatively or cumulatively, a spring unit can be provided which pre-tensions the coil unit in the rotational axis against the magnet unit or counter to the magnet unit. In this case, when the actuation unit is activated, the coil unit can be movable against the force of the spring unit or together with the force of the spring unit so as to enlarge the gap. Alternatively, when the actuation unit is deactivated, the coil unit can be movable by means of the force of the spring unit so as to enlarge the gap.

The axial flux motor advantageously has an output shaft, with the magnet unit being coupled to the output shaft and with the actuation unit being operatively connected to the output shaft. In this case, the output shaft can also have a sleeve-shaped part which is guided in an axially movable manner via the inner output shaft, in particular to axially displace the magnet unit. In the same way, the output shaft can also be connected to the coil unit, with the actuation unit also being operatively connected to the output shaft such that an axial displacement of at least one part of the output shaft or of a sleeve on the output shaft can trigger the axial displacement of the coil unit.

Further advantageously, the axial flux motor has a housing, with the magnet unit and/or the coil unit being axially displaceable relative to the housing when the actuation unit is activated. The actuation unit can be connected to the housing at least at one pivot point in the form of a joint.

The actuation unit preferably has at least one actuation arm which is operatively connected to the magnet unit and/or to the coil unit and/or to the output shaft. In particular, the actuation unit can have a plurality of actuation arms, with one actuation arm being operatively connected to one of the mentioned components in each case.

Furthermore, the actuation unit can have a lift generation means with which the magnet unit and/or the coil unit is displaceable in the rotational axis. The lift generation means can be designed as coils with solenoid, as a motor transmission unit for example with a worm gear transmission or the like. In this case, there is in particular the possibility that the lift generation means is also operatively connected directly to the magnet unit or to the coil unit.

For example, the lift generation means can be received on the output shaft and surround it and a sleeve can be received on the output shaft which interacts with the lift generation means, in particular if the sleeve in turn forms the solenoid of a sucking coil. Of course, the lift generation means can be operatively connected in a simple manner with a linkage to the actuation arm. The actuation arm itself can comprise a driver gable which axially displaces the output shaft or a part connected to the output shaft.

The magnet unit and/or the coil unit can have an axial working gap for an operating mode of the axial flux motor in which the magnet unit and/or the coil unit occupy a distance relative to one another which is unchangeable even in the case of an inactive actuation unit. The motor can in particular be powered in the operating mode. For the position of the actuation unit in the rest position and in the operating position of the axial flux motor, said axial flux motor can have a locking device such that, to maintain the axial working gap or the resting gap, the actuation unit does not have to be powered permanently. The working gap is thereby preferably smaller than the resting gap. In this manner, the motor is more efficient in the operating mode with a smaller gap.

The magnet unit and/or the coil unit can have an axial resting gap for a resting mode of the axial flux motor in which the magnet unit and/or the coil unit have a distance relative to one another which is unchangeable even in the case of an inactive actuation unit or inactive lift generation means. The motor can in particular be de-energized in the rest mode. Thus, a locking device can also be provided to maintain the rest mode, in particular when a drive having an axial flux motor is switched on. Therefore, the magnet unit is rotatable in a manner that is as free of cogging as possible relative to the coil unit by the larger axial resting gap being retained without the actuation unit requiring a power supply for this purpose and representing a resting consumer.

Furthermore, it is advantageously provided that the actuation unit and/or the lift generation means is designed such that or the actuation unit is operatively connected to the magnet unit and/or to the coil unit such that it occupies a stable position in the operating mode for the axial working gap and in the rest mode for the axial resting gap such that in both positions the lift generation means can be de-energized. The actuation unit and/or the lift generation means is in this respect designed such that they form a bistable movement device.

The disclosure is also aimed at a method for operating an axial flux motor according to the above representation, with the method having at least the following steps: Activating the actuation unit, axially displacing the magnet unit and/or the coil unit and transferring the axial flux motor to the operating mode; Operating the axial flux motor; Terminating the operation of the axial flux motor; Activating the actuation unit and axially displacing the magnet unit and/or the coil unit and transferring the axial flux motor to the rest mode. The actual operation of the axial flux motor thereby relates to the step in the method, which takes place between the displacement of the magnet unit and/or the coiling unit so as to reduce the axial gap, such that an axial working gap for the motor operation is set, and the coil unit or magnet unit to be returned, in which the axial gap is enlarged again and forms the resting gap for the switched-off motor.

The lift generation means is thereby in particular powered only to change between the operating mode and the rest mode of the axial flux motor such that either during the operation or in the rest mode of the axial flux motor, the lift generation means receives energy and it represents a consumer.

Furthermore, it is provided that axial displacement of the magnet unit and/or of the coil unit is generated relative to one another along a rotational axis. The rotational axis thereby forms the longitudinal axis of the output shaft of the axial flux motor.

Features and details, which are described in connection with the axial flux motor according to the disclosure, thereby also apply in connection with the method according to the disclosure and vice versa. In this case, the features mentioned in the description and in the claims may each be essential to the disclosure individually by themselves or in combination. In particular, an axial flux motor and a method for operating an axial flux motor are being protected and features, which are described in connection with the axial flux motor, are also applicable in particular when considered individually for the method itself. The disclosure is also aimed at a drive of at least one leaf element of a door, of a gate, of a window, of a person separation device and/or of a partition wall system and the like, comprising such an axial flux motor. Features and details, which are described in connection with the axial flux motor and the method according to the disclosure, thereby also apply in connection with the drive according to the disclosure and vice versa.

According to an additional concept of the disclosure, it is provided that the actuation unit is designed in such manner that it has a sensor, for example a Hall sensor, a capacitive or inductive distance sensor, a rotary encoder or the like such that it can provide a signal to a control unit of the door drive, by means of which the control unit can determine the position of the magnet unit and/or of the coil unit and/or of the output shaft in the rotational axis, in particular along the virtually extended rotational axis, and/or in relation to the rotational angle. In particular, the size of the gap between the magnet unit and the coil unit and/or the rotational angle of the magnet unit and/or of the output shaft can be determined as a result. This enables the gap and/or the rotational angle to be monitored and enables the gap to be controlled or regulated, in particular set.

The resting gap can for example be a measurement of 0.1 mm to 5 mm, in particular 0.2 mm to 4 mm, in particular 0.3 mm to 3 mm, in particular 0.4 mm to 2 mm, in particular 0.5 mm to 1.5 mm, in particular 0.7 mm to 1.0 mm.

The working gap can for example be a measurement of 0.1 mm to 2.0 mm, in particular 0.2 mm to 1.5 mm, in particular 0.3 mm to 1.0 mm, in particular 0.4 mm to 0.8 mm, in particular 0.5 mm to 0.7 mm. In relation to the measurement of the working gap, it can be enlarged, for setting the resting gap, by 10% to 100%, in particular by 20% to 90%, in particular by 30% to 80%, in particular by 40% to 70%, in particular by 50% to 60%.

### BRIEF DESCRIPTION OF THE DRAWINGS

Further measures that improve the disclosure will be outlined in greater detail below together with the description of a preferred exemplary embodiment of the disclosure on the basis of the figures, in which is shown:

FIG. 1 a schematic view of an axial flux motor having an axially movable magnet unit in an operating mode, in which a gap forms a smaller axial working gap between a magnet unit and a coil unit,

FIG. 2 the axial flux motor according to FIG. 1 in a rest mode, in which the gap between the magnet unit and the coil unit forms a larger axial resting gap,

FIG. 3 a schematic view of an axial flux motor having an axially movable coil unit in an operating mode,

FIG. 4 the axial flux motor according to FIG. 3 in a rest mode, in which the gap between the magnet unit and the coil unit is larger and forms an axial resting gap,

FIG. 5 a further exemplary embodiment of an axial flux motor in a schematic representation with an axially movable coil unit, with the actuation unit pivoting an output shaft of the axial flux motor, with the representation showing the operating mode of the motor, and

FIG. 6 the representation of the axial flux motor according to FIG. 5 with an enlarged gap between magnet unit and coil unit for a rest mode.

### DETAILED DESCRIPTION OF THE DRAWINGS

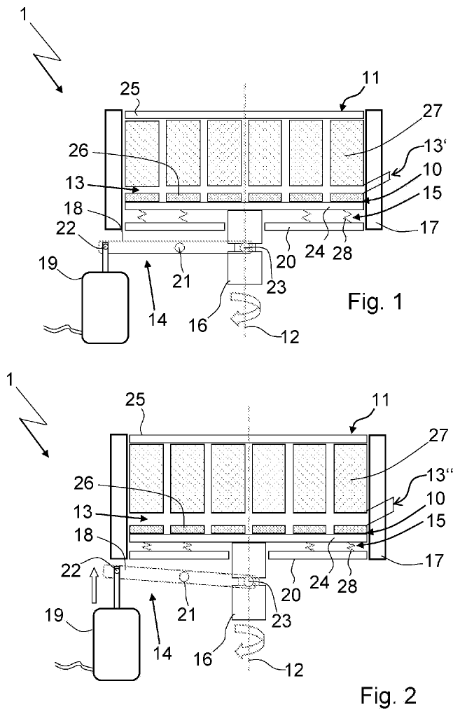

FIGS. 1 and 2 schematically show in different switching states an exemplary embodiment of an axial flux motor 1, which can for example be used to drive a leaf element of a door, of a gate, of a window, of a person separation device, such as a turnstile, or for example also to drive individual leaf elements of a partition wall system. The axial flux motor 1 is represented schematically and has substantially a magnet unit 10 and a coil unit 11 and both units 10, 11 are configured around a rotational axis 12, and for example the magnet unit 10 is connected to an output shaft 16 in a rotationally-rigid manner. Consequently, the coil unit 11 is rigidly connected to a housing 17 of the axial flux motor 1.

The magnet unit 10 has a plurality of permanent magnets 26 and the coil unit 11 has a plurality of coils 27. The permanent magnets 26 are attached on a magnet support 24 and the coils 27 on a coil support 25.

A gap 13 is formed between the magnet unit 10 and the coil unit 11. The gap 13 is designed as an axial working gap 13′ in FIG. 1 and, according to

FIG. 2, the gap 13 is designed as an axial resting gap 13″. In order to change the gap 13 between the working gap 13′ according to FIG. 1 and the resting gap 13″ according to FIG. 2, i.e. to vary the distance between the magnet unit 10 and the coil unit 11, an actuation unit 14 designed according to the disclosure is used which, according to the represented exemplary embodiment of FIGS. 1 and 2, is operatively connected to the magnet unit 10 such that it is changeable in the axial position relative to the coil unit 11 and therefore also relative to the housing 17. By activating the actuation unit 14, the magnet unit 10 can be changed in position along the rotational axis 12.

To this end, the actuation unit 14 has an actuation arm 18 which is connected to a lift generation means 19. The lift generation means 19 is for example designed as a solenoid coil and the solenoid is retraced in FIG. 1 and extended in FIG. 2, as the arrow in FIG. 2 represents. As a result, the actuation arm 18 rotates in a joint 21, with the actuation arm 18 having a driver gable 23 in order to act for example on the output shaft 16, and in order to displace the magnet unit 10 along the rotational axis 12.

On the side facing away from the driver gable 23, the actuation arm 18 has a linkage 22 on which the anchor of the lift generation means 19 acts.

If the magnet unit 10 with the permanent magnets 26 is displaced along the rotational axis 12 such that the distance to the coil unit 11 is enlarged, this occurs with compression of the spring elements 28 of the spring unit 15, with the spring elements 28 being supported on a spring plate 20. This can for example take place by powering the lift generation means 19. If, according to FIG. 2, the axial flux motor 1 is located in the rest mode such that the axial flux motor 1 is de-energized, a locking device can serve in a manner not represented such that the lift generation means 19 can also be de-energized again and the state according to FIG. 2, in which the axial flux motor 1 is located in the rest mode, takes place so as to maintain the compression of the spring elements 28 and, in this state, the axial resting gap 13″ is set such that, when the output shaft 16, which is for example coupled to a door leaf, is manually rotated, only a small cogging torque results, which is notably lower than in the case of an axial working gap 13′ according to FIG. 1.

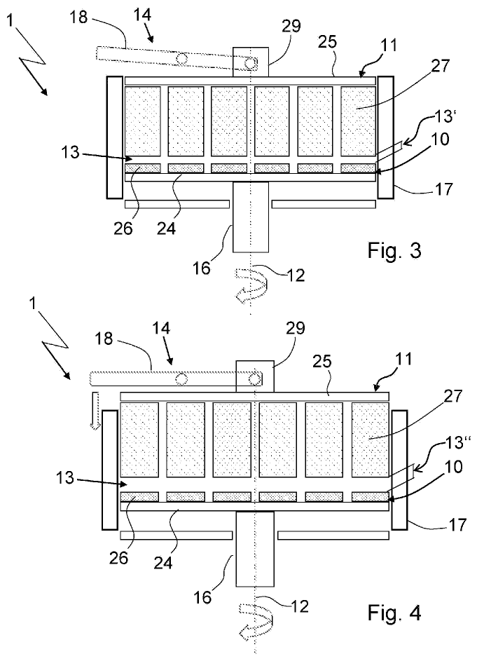

FIGS. 3 and 4 show an alternative exemplary embodiment of the axial flux motor 1, in which the actuation unit 14 is operatively connected to the coil unit 11 via a pin 29. If the actuation unit 14 is activated with the actuation arm 18 in the same manner as described in connection with FIGS. 1 and 2, the gap 13 between the magnet unit 10 and the coil unit 11 is enlarged according to this exemplary embodiment, and the gap 13 changes from an axial working gap 13′ according to FIG. 3 to an axial resting gap 13″ according to FIG. 4 such that the axial flux motor 1 is transferred from an operating mode to a rest mode.

The magnet unit 10 with the magnet support 24 and the permanent magnets 26 attached thereto remains unchanged in position relative to the housing 17 along the rotational axis 12, while the coil unit 11 with the coil support 25 and the coils 27 attached thereto is displaced along the rotational axis 12. This occurs when the actuation unit 14 is activated in the direction of the arrow shown, by the actuation arm 18 of the actuation unit 14 acting on the pin 29, which is arranged on the rear side of the coil unit 11 and performs the lifting movement with the coil unit 11.

As a result, the gap 13 is enlarged in the same manner from a working gap 13′ to a resting gap 13″, such that the operating mode according to FIG. 3 enables a normal operation of the axial flux motor 1 and the rest mode according to FIG. 4 enables a simplified manual rotation of the output shaft 16, which is connected to the magnet unit 10 comprising the magnet support 24 and the permanent magnets 26, without larger cogging torques between the coils 27 of the coil unit 11 and the permanent magnets 26 of the magnet unit 10 making the rotation of the output shaft 16 difficult.

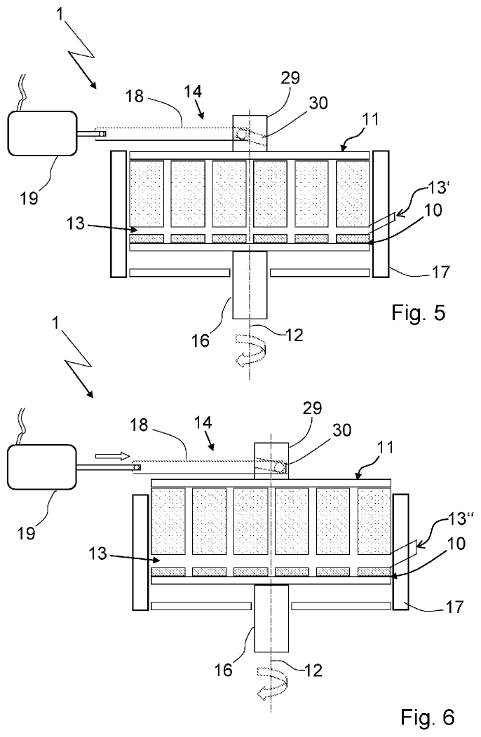

FIGS. 5 and 6 show an alternative configuration of the actuation unit 14, with the coil unit 11 also being displaceable along the rotational axis 12 according to this exemplary embodiment, while the magnet unit 10 remains non-displaced relative to the housing 17 and therefore occupies a fixed position in relation to the housing 17.

The actuation unit 14 has an actuation arm 18, which extends tapering perpendicularly on the rotational axis 12 and is displaceable in this extension, and the displacement can in turn be activated with the lift generation means 19. A connecting rod 30 is introduced in a pin 29, which is rigidly connected to the coil unit 11, and, in the position according to FIG. 5, the actuation arm 18 is in a first position which moves the coil unit 11 in the direction of the magnet unit 10 via the obliquely running connecting rod 30 such that the axial working gap 13′ is set. If the lift generation means 19 is activated, and the actuation arm 18 is displaced further forwards in the direction of the rotational axis 12, the pin 29 is displaced in the rotational axis 12 via the connecting rod 30 such that the coil unit 11 is also displaced. As a result, the gap 13 in relation to an axial resting gap 13″ is enlarged according to FIG. 6, which represents the rest mode of the axial flux motor 1 in this respect.

The design of the disclosure is not restricted to the preferred exemplary embodiment indicated above. In fact, a number of variants is conceivable, which makes use of the solution represented, even in the case of embodiments that are designed fundamentally differently. All features and/or advantages emerging from the claims, the description or the drawings, including constructive details or spatial arrangements, may be essential to the disclosure by themselves and in the most varied combinations.

1. An axial flux motor, for driving at least one leaf element of a door, of a gate, of a window, of a person separation device and/or of a partition wall system, comprising: a magnet unit and a coil unit, wherein the magnet unit is designed so as to be rotatable about a rotational axis, and wherein a gap is designed between the magnet unit and the coil unit,
wherein
an actuation unit is provided with which the gap between the magnet unit and the coil unit is variable.

2. The axial flux motor according to claim 1,
wherein
the actuation unit is in interaction with the magnet unit such that the magnet unit is displaceable relative to the coil unit in the rotational axis by an activation of the actuation unit.

3. The axial flux motor according to claim 1,
wherein
the actuation unit or another actuation unit is in interaction with the coil unit such that the coil unit is displaceable relative to the magnet unit in the rotational axis by an activation of the actuation unit.

4. The axial flux motor according to claim 1,
wherein
a spring unit is provided which pre-tensions the magnet unit in the rotational axis with or against the coil unit or with or counter to the coil unit.

5. The axial flux motor according to claim 1,
wherein
the axial flux motor has an output shaft, wherein the magnet unit is connected to the output shaft and wherein the actuation unit is operatively connected to the output shaft.

6. The axial flux motor according to claim 1,
wherein
the axial flux motor has a housing, wherein the magnet unit and/or the coil unit is axially displaceable relative to the housing when the actuation unit is activated.

7. The axial flux motor according to claim 1,
wherein
the actuation unit has an actuation arm which is operatively connected to the magnet unit and/or to the coil unit and/or to the output shaft.

8. The axial flux motor according to claim 1,
wherein
the actuation unit has a lift generation means with which the magnet unit and/or the coil unit is displaceable in the rotational axis.

9. The axial flux motor according to claim 8,
wherein
the lift generation means is operatively connected to the actuation arm.

10. The axial flux motor according to claim 1,
wherein
the magnet unit and/or the coil unit have an axial working gap for an operating mode of the axial flux motor in which the magnet unit and/or the coil unit occupy a distance relative to one another which is unchangeable even in the case of an inactive actuation unit.

11. The axial flux motor according to claim 1,
wherein
the magnet unit and/or the coil unit have an axial resting gap for a rest mode of the axial flux motor in which the magnet unit and/or the coil unit have a distance relative to one another which is unchangeable even in the case of an inactive actuation unit.

12. The axial flux motor according to claim 1,
wherein
the actuation unit and/or the lift generation means is designed or in that the actuation unit is operatively connected to the magnet unit and/or to the coil unit such that it occupies a stable position in the operating mode for the axial working gap and in the rest mode for the axial resting gap such that in both positions the lift generation means can be de-energized.

13. A method for operating an axial flux motor according to claim 1, the method includes the following steps:
activating the actuation unit,
axially displacing the magnet unit and/or the coil unit and transferring the axial flux motor to the operating mode,
operating the axial flux motor,
terminating the operation of the axial flux motor,
activating the actuation unit, and
axially displacing the magnet unit and/or the coil unit and transferring the axial flux motor to the rest mode.

14. The method according to claim 13,
wherein
the lift generation means is powered only to change between the operating mode and the rest mode of the axial flux motor.

15. A drive of at least one leaf element of a door, of a gate, of a window, of a person separation device and/or of a partition wall system, having an axial flux motor designed according to claim 1.
